(19) United States
(12) Patent Application Publication
(10) Pub. No.: US 2025/0187837 A1
(43) Pub. Date: Jun. 12, 2025

(54) Article Shipping System

(71) Applicant: Daifuku Co., Ltd., Osaka-shi (JP)

(72) Inventor: Takashi Ukon, Osaka-shi (JP)

(21) Appl. No.: 18/975,490

(22) Filed: Dec. 10, 2024

(30) Foreign Application Priority Data
Dec. 11, 2023 (JP) 2023-208687

(51) Int. Cl. B65G 1/137

(52) U.S. Cl. CPC B65G 1/1378

(57) ABSTRACT

In an article shipping system, a container forming device forms a shipment container that has a size necessary to house articles in a housing sequence determined in housing sequence determination processing, as a target shipment container relating to target order information. A control system controls a conveyance system in a manner such that (i) one or more target conveyance containers in which articles indicated by the target order information are housed arrive at a consolidation work area in a sequence corresponding to the housing sequence determined in the housing sequence determination processing, and (ii) the target shipment container arrives at the consolidation work area before the one or more target conveyance containers arrive.

### CROSS-REFERENCE TO RELATED APPLICATION

This application claims priority to Japanese Patent Application No. 2023-208687 filed Dec. 11, 2023, the disclosure of which is hereby incorporated by reference in its entirety.

### BACKGROUND OF THE INVENTION

### 1. Field of the Invention

The present invention relates to an article shipping system configured to house articles in a shipment container in accordance with order information including: designated types that are types of articles designated for each shipment destination; and type-specific designated numbers that are numbers of articles designated for the respective designated types.

### 2. Description of Related Art

For example, Japanese Patent No. 7264702 (JP 7264702) discloses a technology for forming a container according to the size of an article while the article is conveyed in a facility. The article is housed in the container right after the formation of the container. The container is used to ship the housed article, for example.

In a facility in which a plurality of pieces of order information designating types and numbers of articles are handled, various types of articles having different sizes are shipment targets, and a plurality of articles are collectively shipped in various combinations. Accordingly, when applying the technology described in JP 7264702 to such a facility, it is necessary to form a shipment container having a size that matches a combination of articles indicated by order information. Even if such a shipment container can be formed, there is a restriction that the shipment container formed for the specific order information needs to be used in consolidation work for housing the group of articles indicated by the order information in the shipment container. Therefore, it is difficult to adjust timings at which the group of articles and the shipment container are conveyed to an area in which the consolidation work is performed, and the consolidation work may become complex.

### SUMMARY OF THE INVENTION

In view of the above circumstances, there is demand for a technology that makes it possible to supply a shipment container having a size that matches the total size of a group of articles indicated by order information at an appropriate timing and simplify the consolidation work.

A technology for solving the above issues is as follows.

An article shipping system configured to house at least one article in a shipment container in accordance with order information including at least one designated type of article and a corresponding type-specific designated number of articles for a shipment destination, the article shipping system including:
a container forming device configured to form the shipment container in any of a plurality of sizes by processing a raw material;
a housing work area in which article housing work is performed based on one or more pieces of the order information by housing one or more articles of one designated type in a target container that is at least one of the shipment container and a conveyance container;
a consolidation work area in which consolidation work is performed to, for each designated type in a certain piece of the order information, house the corresponding type-specific designated number of articles in the shipment container;
a conveyance system configured to convey the shipment container and the conveyance container; and
a control system configured to control the container forming device and the conveyance system,
wherein the control system executes housing sequence determination processing for determining a housing sequence in which articles of all designated types included in target order information are housed type by type in the shipment container, the target order information being each order information,
the container forming device forms a shipment container that has a size necessary to house the articles in the housing sequence determined in the housing sequence determination processing, as a target shipment container relating to the target order information, and
the control system controls the conveyance system in a manner such that, while the target shipment container and one or more target conveyance containers, in which the articles indicated by the target order information are housed, are conveyed to the consolidation work area, (i) the one or more target conveyance containers arrive at the consolidation work area in a sequence corresponding to the housing sequence determined in the housing sequence determination processing, and (ii) the target shipment container arrives at the consolidation work area before the target conveyance containers arrive.

According to this configuration, when the consolidation work for the plurality of articles indicated by the target order information is performed in the consolidation work area, it is possible to complete the consolidation work relating to the target order information by merely housing, in the target shipment container that arrives at the consolidation work area first, the articles housed in the target conveyance containers arriving after the target shipment container in the sequence in which the conveyance containers arrive. Moreover, the target shipment container is formed into a size necessary to house the articles in the determined housing sequence, and accordingly, it is easy to reduce the amount of dead space in the target shipment container when the consolidation work is complete and all the articles indicated by the target order information are housed in the target shipment container. Therefore, the articles can be housed with high efficiency. As described above, with this configuration, it is possible to supply a shipment container having a size that matches the total size of a group of articles indicated by order information at an appropriate timing and simplify the consolidation work.

Further features and advantages of the technology according to the present disclosure will be clarified by exemplary and non-limiting embodiments described below with reference to the drawings.

### BRIEF DESCRIPTION OF THE DRAWINGS

FIG. 1 is a schematic diagram of an article shipping system.

FIG. 2 is a control block diagram.

FIG. 3 is a diagram for describing consolidation work.

FIG. 4 is a flowchart showing an execution procedure of housing sequence determination processing.

FIG. 5 is a diagram for describing the housing sequence determination processing.

FIG. 6 is a schematic diagram of an article shipping system according to a second embodiment.

FIG. 7 is a schematic diagram of an article shipping system according to a third embodiment.

### DESCRIPTION OF THE INVENTION

An article shipping system is a system configured to house articles in a shipment container in accordance with order information including: designated types that are types of articles designated for each shipment destination; and type-specific designated numbers that are numbers of articles designated for the respective designated types. The following describes embodiments of the article shipping system with reference to the drawings.

### First Embodiment

First, the following describes a first embodiment of the article shipping system.

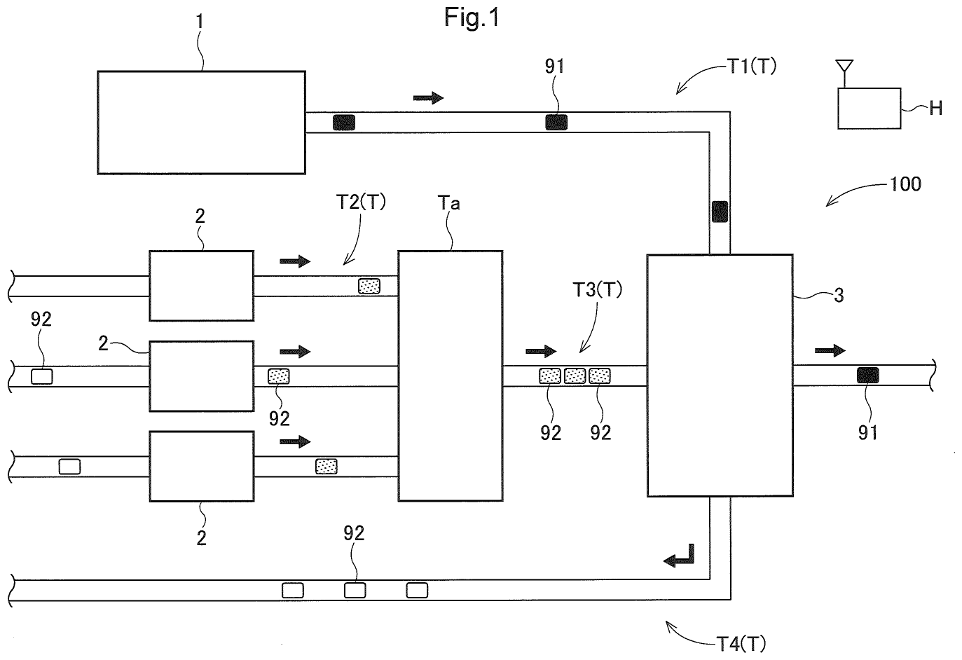

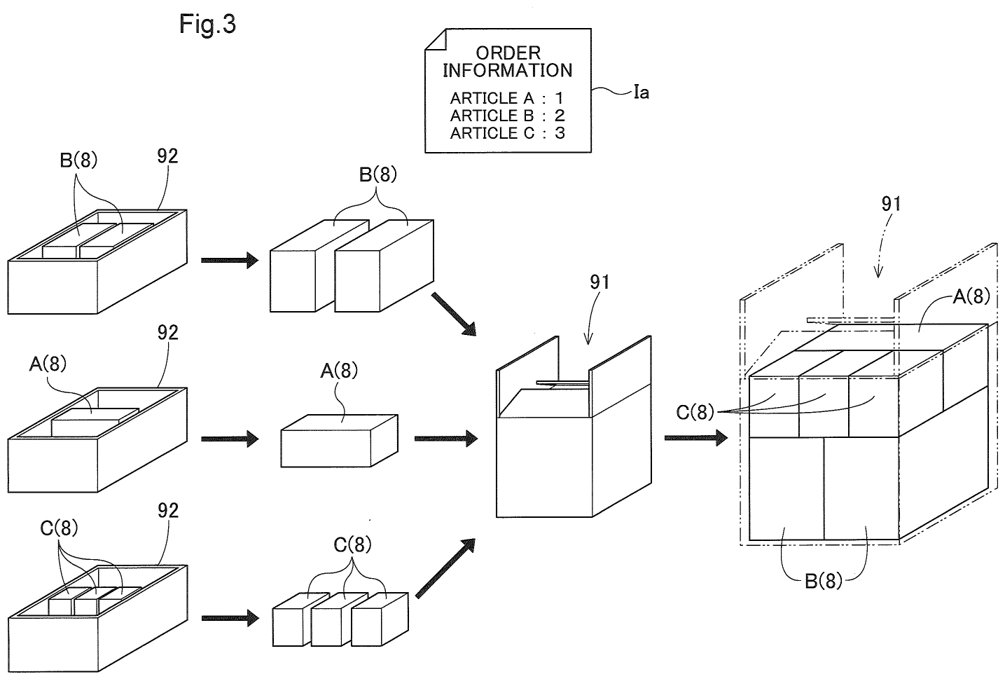

As shown in FIG. 1, conveyance containers 92 and shipment containers 91 are conveyed between steps in an article shipping system 100. Articles 8 of the same type (see FIG. 3) are housed in each conveyance container 92. A plurality of types of articles 8 housed in a plurality of conveyance containers 92 are collectively housed in a shipment container 91. The plurality of types of articles 8 housed in the shipment container 91 are shipped to a designated shipment destination. The plurality of types of articles 8 collectively housed in the shipment container 91 are determined based on order information Ia (see FIG. 3).

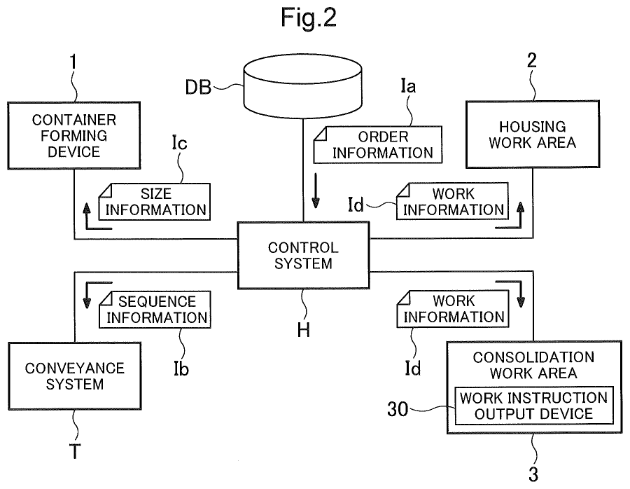

As shown in FIGS. 1 and 2, the article shipping system 100 includes a container forming device 1, a housing work area 2, a consolidation work area 3, a conveyance system T, and a control system H.

The container forming device 1 is configured to form shipment containers 91 of a plurality of sizes by processing a raw material. The container forming device 1 forms a container from a stiff sheet-shaped or plate-shaped raw material. Thus, the shipment containers 91 are formed. The formed shipment containers 91 are corrugated boxes, for example.

The size of a shipment container 91 that is to be formed by the container forming device 1 is variable. The size of the shipment container 91 is determined such that the shipment container 91 can accommodate all articles 8 indicated by order information Ia. The size of the shipment container 91 is approximate to the total size of all the articles 8 indicated by the order information Ia. Thus, the amount of dead space in the shipment container 91 can be reduced when all the articles 8 indicated by the order information Ia are housed in the shipment container 91. Therefore, the articles 8 can be housed with high efficiency. The container forming device 1 obtains size information Ic (see FIG. 2) from the control system H and forms the shipment container 91 based on the size information Ic as described later in detail.

The housing work area 2 is an area in which article housing work is performed based on one or more pieces of order information Ia by housing articles 8 of one designated type in a target container that is at least one of a shipment container 91 and a conveyance container 92.

In the present embodiment, the article housing work is performed in the housing work area 2 with use of a conveyance container 92 as the target container. That is to say, only the conveyance containers 92 are used as target containers, out of the shipment containers 91 and the conveyance containers 92. The conveyance containers 92 are used in the article housing work, and articles 8 are housed in the conveyance containers 92 in the article housing work. In the present embodiment, the shipment containers 91 are not used in the article housing work.

A plurality of types of articles 8 supplied from an automatic warehouse (not shown), for example, are disposed in the housing work area 2. Here, “disposed” means that the articles 8 are placed in the housing work area 2 at least until the article housing work is complete. The article housing work is performed for each piece of order information Ia. In other words, one conveyance container 92 is used for article housing work relating to a piece of order information Ia. Another conveyance container 92 is used for article housing work relating to another piece of order information Ia.

Articles 8 of one type among designated types included in the order information Ia are housed in a conveyance container 92 in the article housing work. One or more articles 8 of the same type are housed in the conveyance container 92 in the article housing work. In the illustrated example, the article shipping system 100 includes a plurality of housing work areas 2. The article housing work is performed in each housing work area 2. Each housing work area 2 (more specifically, a control device or the like that manages the area) obtains work information Id from the control system H as described later in detail. The article housing work is performed based on the work information Id. Note that the article housing work is performed by a worker and/or a robot.

The consolidation work area 3 is located downstream of both the container forming device 1 and the housing work areas 2 in a conveyance direction of the conveyance system T. A shipment container 91 formed by the container forming device 1 and conveyance containers 92 in which articles 8 have been housed through the article housing work in the housing work areas 2 are conveyed to the consolidation work area 3 by the conveyance system T.

Consolidation work is performed in the consolidation work area 3 to house, for each designated type in a certain piece of order information Ia, the corresponding type-specific designated number of articles 8 in the shipment container 91 as shown in FIG. 3. In the present embodiment, the consolidation work is performed by a worker.

In the illustrated example, all designated types included in the order information Ia are “article A, article B, and article C”. The number (type-specific designated number) of articles 8 is set for each of the designated types. In the illustrated example, the order information Ia indicates “article A: 1, article B: 2, and article C: 3”. In the consolidation work, all these articles 8 indicated by the order information Ia are housed in the shipment container 91 formed by the container forming device 1. As described above, the amount of dead space in the shipment container 91 in which all the articles 8 indicated by the order information Ia have been housed is small.

As shown in FIG. 2, a work instruction output device 30 for outputting an instruction regarding the consolidation work to the worker is installed in the consolidation work area 3 in the present embodiment. For example, the work instruction output device 30 includes a monitor and displays (outputs) an instruction regarding the consolidation work on the monitor. The work instruction output device 30 obtains work information Id from the control system H and outputs the work information Id as described later in detail. The worker performs the consolidation work based on the work information Id output by the work instruction output device 30.

As shown in FIGS. 1 and 2, the conveyance system T is configured to convey the shipment container 91 and the conveyance containers 92. The conveyance system T includes a conveyor as a main component. However, the conveyance system T may also include a conveyance device other than a conveyor, such as an unmanned conveyance vehicle.

The conveyance system T in the present embodiment includes a temporary storage device Ta for temporarily storing the conveyance containers 92.

The temporary storage device Ta has a function of carrying out the stored conveyance containers 92. The temporary storage device Ta is capable of collectively carrying out a given number of conveyance containers 92 arranged in a suitable sequence at a time. The temporary storage device Ta includes a conveyance device such as a conveyor or a conveyance cart. The temporary storage device Ta obtains sequence information Ib (see FIG. 2) from the control system H and carries out the conveyance containers 92 based on the sequence information Ib as described later in detail.

In the present embodiment, the conveyance system T includes a first conveyance system T1, a second conveyance system T2, and a third conveyance system T3. In this example, the conveyance system T further includes a fourth conveyance system T4 in addition to these conveyance systems.

The first conveyance system T1 conveys the shipment container 91 formed by the container forming device 1. In the example shown in FIG. 1, the first conveyance system T1 conveys the shipment container 91 along a route from the container forming device 1 to the consolidation work area 3.

The second conveyance system T2 conveys the conveyance containers 92 in which articles 8 have been housed through the article housing work in the housing work areas 2. In the example shown in FIG. 1, the second conveyance system T2 conveys the conveyance containers 92 along a route from each housing work area 2 to the temporary storage device Ta.

The third conveyance system T3 conveys a plurality of conveyance containers 92 that are stored in the temporary storage device Ta and associated with each other. The “plurality of conveyance containers 92 associated with each other” are a plurality of conveyance containers 92 housing articles 8 indicated by a piece of order information Ia. In the example shown in FIG. 1, the third conveyance system T3 conveys the plurality of conveyance containers 92 along a route from the temporary storage device Ta to the consolidation work area 3.

The fourth conveyance system T4 conveys empty conveyance containers 92 that have been used in the consolidation work. In the example shown in FIG. 1, the fourth conveyance system T4 conveys the empty conveyance containers 92 along a route returning from the consolidation work area 3 to each step. For example, the fourth conveyance system T4 may be configured to convey the empty conveyance containers 92 along a route from the consolidation work area 3 to each housing work area 2. With this configuration, it is possible to reuse the empty conveyance containers 92 conveyed by the fourth conveyance system T4 in the article housing work performed in the housing work areas 2.

The control system H is configured to control the container forming device 1 and the conveyance system T. The control system H can be configured with use of a plurality of pieces of hardware and a plurality of pieces of software. The control system H includes a processor such as a microcomputer and a peripheral circuit such as a memory, for example. Each function is realized through cooperation between these pieces of hardware and a program executed on a processor such as a computer.

Here, a plurality of pieces of order information Ia are handled in the article shipping system 100. In the present specification, when focusing on specific order information Ia among the plurality of pieces of order information Ia, the specific order information Ia will be referred to as “target order information Ia”. That is to say, target order information Ia referred to in the present specification is each of the plurality of pieces of order information Ia.

The control system HI is configured to execute housing sequence determination processing for determining a housing sequence in which articles 8 of all designated types included in the target order information Ia are housed type by type in the shipment container 91.

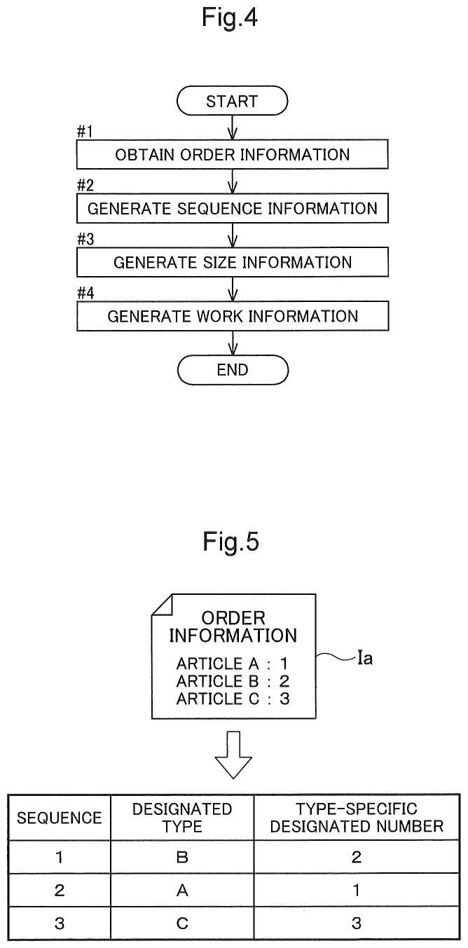

As shown in FIG. 4, the housing sequence determination processing is executed in the following procedure in the present embodiment. The control system H obtains order information Ia in the housing sequence determination processing (step #1). In the present embodiment, the control system H obtains the order information Ia from a database DB (see FIG. 2).

After the processing in step #1, the control system H generates sequence information Ib based on the obtained order information Ia (step #2). The “sequence information Ib” is information regarding the housing sequence in which the articles 8 indicated by the target order information Ia are housed type by type in the shipment container 91. An appropriate housing sequence is determined by performing a simulation based on various conditions. For example, the various conditions include “the larger an article 8 is, the earlier the article 8 is housed”, “the heavier an article 8 is, the earlier the article 8 is housed”, and “articles 8 of the same type are housed in a group”. Information indicating the determined housing sequence is generated as the sequence information Ib by the control system H.

In the example shown in FIG. 5, as a result of the housing sequence determination processing being executed in the case where the target order information Ia indicates “article A: 1, article B: 2, and article C: 3”, it is determined that two articles B will be initially housed in the shipment container 91, an article A will be housed next in the shipment container 91, and three articles C will be housed lastly in the shipment container 91.

As shown in FIG. 4, after the processing in step #2, the control system H generates size information Ic based on the obtained order information Ia (step #3). The “size information Ic” is information regarding the size of a shipment container 91 to be formed by the container forming device 1. For example, the size of the shipment container 91 is determined by calculating a plurality of arrangement patterns of articles 8 when all the articles 8 indicated by the order information Ia are housed in the shipment container 91 and selecting an arrangement pattern that minimizes the size of the shipment container 91 among the plurality of arrangement patterns.

After the processing in step #3, the control system H generates work information Id based on the obtained order information Ia (step #4). The “work information Id” is information regarding the article housing work to be performed in the housing work areas 2 or the consolidation work to be performed in the consolidation work area 3. For example, work information Id regarding the article housing work indicates designated types of articles 8 to be housed in conveyance containers 92 in the article housing work and type-specific designated numbers designated for the respective designated types. Also, work information Id regarding the consolidation work indicates, for example, the housing sequence of all the articles 8 that are indicated by the order information Ia and to be housed in the shipment container 91 in the consolidation work and housing positions of those articles 8.

Note that the steps #2 to #4 described above do not necessarily have to be carried out in the sequence shown in FIG. 4. These steps #2 to #4 may also be carried out simultaneously.

As shown in FIG. 2, the control system H in the present embodiment transmits the generated size information Ic to the container forming device 1. The container forming device 1 forms a shipment container 91 in accordance with the size information Ic. That is to say, the container forming device 1 forms a shipment container 91 that has a size necessary to house the articles 8 in the housing sequence determined in the housing sequence determination processing, as a target shipment container 91 relating to the target order information Ia. Note that, after forming the shipment container 91, the container forming device 1 converts the target order information Ia, based on which the container has been formed, into a one-dimensional code or a two-dimensional code and attaches the code to the shipment container 91. The code is pasted or printed on the shipment container 91, for example.

The control system H in the present embodiment transmits the generated sequence information Ib to the conveyance system T. The conveyance system T conveys the shipment container 91 and the conveyance containers 92 in accordance with the sequence information Ib. The conveyance system T conveys the shipment container 91 in a manner such that the shipment container 91 arrives at the consolidation work area 3 before the conveyance containers 92 in which the articles 8 indicated by the target order information Ia are housed arrive at the consolidation work area 3. That is to say, the control system H controls the conveyance system T in a manner such that, while the target shipment container 91 and one or more target conveyance containers 92 in which the articles 8 indicated by the target order information Ia are housed are conveyed to the consolidation work area 3 as shown in FIG. 1, (i) the one or more target conveyance containers 92 arrive at the consolidation work area 3 in a sequence corresponding to the housing sequence determined in the housing sequence determination processing, and (ii) the target shipment container 91 arrives at the consolidation work area 3 before the one or more target conveyance containers 92 arrive. In this example, the control system H controls the conveyance system T in a manner such that the target shipment container 91 relating to the target order information Ia arrives at the consolidation work area 3 first and thereafter the plurality of target conveyance containers 92 housing the articles 8 indicated by the target order information Ia arrive at the consolidation work area 3 in the housing sequence determined in the housing sequence determination processing. However, the plurality of target conveyance containers 92 do not necessarily have to arrive at the consolidation work area 3 in the housing sequence described above. The sequence in which these conveyance containers 92 arrive may be changed as long as all the articles 8 indicated by the target order information Ia can be housed in the target shipment container 91. The consolidation work is basically performed in the housing sequence determined in the housing sequence determination processing, but in the above case, may be performed in the sequence in which the plurality of target conveyance containers 92 arrive.

In the present embodiment, the temporary storage device Ta stores the target conveyance containers 92 until all the target conveyance containers 92 relating to the target order information Ia are conveyed to the temporary storage device Ta. The control system H controls the container forming device 1 in a manner such that the target shipment container 91 is formed after all the target conveyance containers 92 relating to the target order information Ia have been stored, and controls the conveyance system T in a manner such that the formed target shipment container 91 arrives at the consolidation work area 3 by being conveyed along a route that does not pass through the temporary storage device Ta. In this example, the target conveyance containers 92 are conveyed to the consolidation work area 3 with use of the second conveyance system T2 and the third conveyance system T3. On the other hand, the target shipment container 91 is conveyed to the consolidation work area 3 with use of the first conveyance system T1 other than these conveyance systems.

The control system HI then controls the conveyance system T in a manner such that (i) the target conveyance containers 92 stored in the temporary storage device Ta are carried out from the temporary storage device Ta toward the consolidation work area 3 in a sequence corresponding to the housing sequence determined in the housing sequence determination processing, and (ii) the target shipment container 91 arrives at the consolidation work area 3 before the target conveyance containers 92 arrive at the consolidation work area 3.

In the present embodiment, the control system H transmits work information Id regarding the article housing work to the housing work areas 2. The article housing work is performed in accordance with the work information Id in the housing work areas 2.

In the present embodiment, the control system H transmits work information Id regarding the consolidation work to the consolidation work area 3. The consolidation work is performed in accordance with the work information Id in the consolidation work area 3.

In the present embodiment, the work instruction output device 30 is installed in the consolidation work area 3 as described above. The work information Id transmitted from the control system H is output by the work instruction output device 30. That is to say, the work instruction output device 30 outputs at least some of contents determined in the housing sequence determination processing in the consolidation work relating to the target order information Ia. The work information Id output by the work instruction output device 30 is displayed on a monitor that is used by the worker, for example. The worker performs the consolidation work in accordance with the work information Id. Note that outputting the work information

Id includes outputting a text indicating the housing sequence in which the articles 8 are to be housed in the target shipment container 91 and/or an image (showing housing positions).

As described above, in the article shipping system 100, the target shipment container 91 is formed into an appropriate size based on the target order information Ia. The target shipment container 91 arrives at the consolidation work area 3 earlier than the target conveyance containers 92 housing the articles 8 indicated by the target order information Ia. Thereafter, the plurality of target conveyance containers 92 housing the articles 8 indicated by the target order information Ia arrive at the consolidation work area 3 in a manner such that these articles 8 are immediately supplied to the consolidation work area 3 in the housing sequence determined in the housing sequence determination processing. The worker in the consolidation work area 3 can complete the consolidation work relating to the target order information Ia by merely housing, in the target shipment container 91 that arrives at the consolidation work area 3 first, the articles 8 housed in the target conveyance containers 92 arriving after the target shipment container 91 in the sequence in which the conveyance containers 92 arrive. Therefore, with the article shipping system 100 described above, it is possible to supply a target shipment container 91 having a size that matches the total size of a group of articles indicated by target order information Ia at an appropriate timing and simplify the consolidation work.

### Second Embodiment

Next, the following describes a second embodiment of the article shipping system, mainly describing differences from the first embodiment described above. Matter that is not particularly mentioned is the same as in the first embodiment described above.

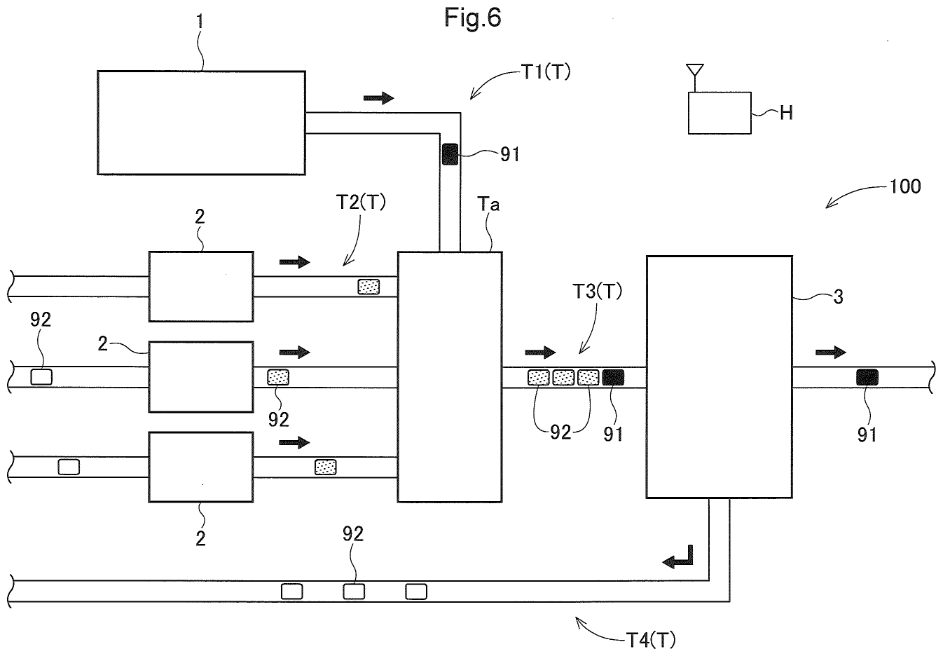

FIG. 6 is a schematic diagram of an article shipping system 100 according to the second embodiment.

As shown in FIG. 6, the conveyance system T is configured to convey an empty shipment container 91 formed by the container forming device 1 to the temporary storage device Ta. In the present embodiment, the first conveyance system Tl is configured to convey the shipment container 91 along a route from the container forming device 1 to the temporary storage device Ta.

The temporary storage device Ta is configured to store the target shipment container 91 and the target conveyance containers 92 until all of the target shipment container 91 and the target conveyance containers 92 relating to the target order information Ia are conveyed to the temporary storage device Ta.

The control system H controls the conveyance system T in a manner such that the target conveyance containers 92 stored in the temporary storage device Ta are carried out from the temporary storage device Ta toward the consolidation work area 3 in a sequence corresponding to the housing sequence determined in the housing sequence determination processing after the target shipment container 91 stored in the temporary storage device Ta is carried out from the temporary storage device Ta toward the consolidation work area 3.

In the present embodiment, the control system H controls the conveyance system T in a manner such that the target shipment container 91 and the plurality of target conveyance containers 92 are carried out in series from the temporary storage device Ta. Furthermore, the conveyance system T carries out the target shipment container 91 and the plurality of target conveyance containers 92 from the temporary storage device Ta (the control system H controls the conveyance system T to do so) in a manner such that the shipment container 91 leads the conveyance containers 92 and the conveyance containers 92 follow the shipment container 91 in the housing sequence determined in the housing sequence determination processing. In the illustrated example, three target conveyance containers 92 are carried out successively from the temporary storage device Ta following the target shipment container 91. These containers are conveyed by the third conveyance system T3 from the temporary storage device Ta to the consolidation work area 3.

### Third Embodiment

Next, the following describes a third embodiment of the article shipping system, mainly describing differences from the first embodiment described above. Matter that is not particularly mentioned is the same as in the first embodiment described above.

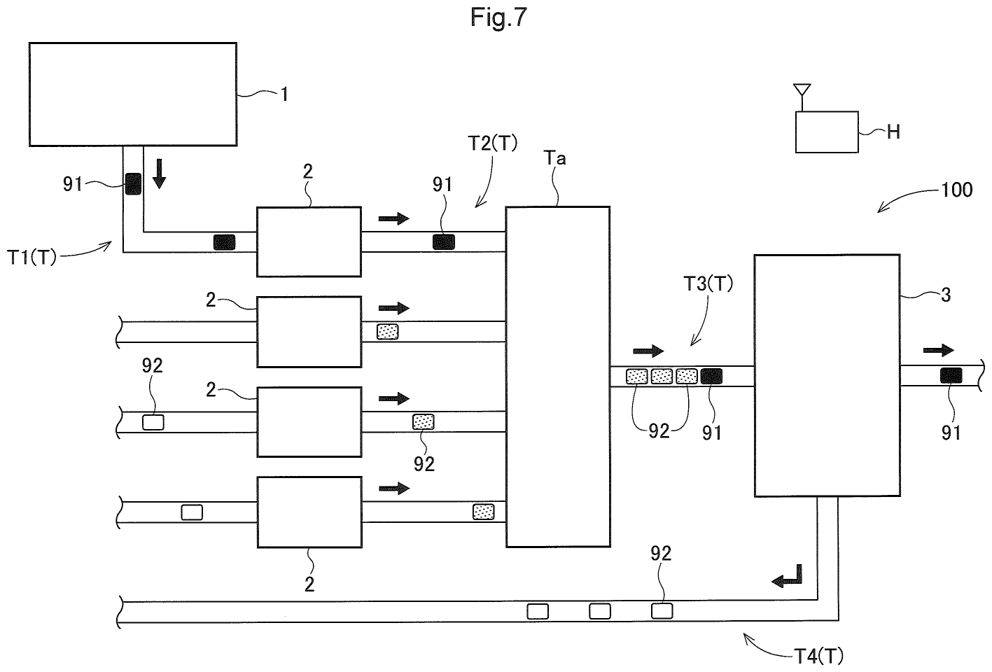

FIG. 7 is a schematic diagram of an article shipping system 100 according to the third embodiment.

As shown in FIG. 7, the conveyance system T is configured to convey an empty shipment container 91 formed by the container forming device 1 to a housing work area 2. In the present embodiment, the first conveyance system Tl is configured to convey the shipment container 91 along a route from the container forming device 1 to the housing work area 2.

In the present embodiment, the article housing work is performed in the housing work areas 2 with use of the shipment container 91 and conveyance containers 92 as target containers. That is to say, articles 8 are housed not only in the conveyance containers 92 but also in the shipment container 91 through the article housing work in the housing work areas 2.

Articles 8 of one type are housed in the shipment container 91. This also applies to cases where articles 8 are housed in the conveyance containers 92. For example, when designated types included in the target order information Ia are “article A, article B, and article C”, articles 8 of one of these three types are housed in the shipment container 91. In this case, articles 8 of a type that are to be housed first according to the housing sequence determined in the housing sequence determination processing are preferably housed in the shipment container 91. Thus, a part of the consolidation work that would otherwise be performed in the consolidation work area 3 can be performed in the housing work area 2.

The temporary storage device Ta is configured to store the target shipment container 91 and the target conveyance containers 92 until all of the target shipment container 91 and the target conveyance containers 92 relating to the target order information Ia are conveyed to the temporary storage device Ta.

The control system HI controls the conveyance system T in a manner such that the target shipment container 91 and the target conveyance containers 92 stored in the temporary storage device Ta are carried out from the temporary storage device Ta toward the consolidation work area 3 in a sequence corresponding to the housing sequence determined in the housing sequence determination processing.

In the present embodiment, the control system H controls the conveyance system T in a manner such that the target shipment container 91 and the plurality of target conveyance containers 92 are carried out in series from the temporary storage device Ta. Furthermore, the conveyance system T carries out the target shipment container 91 and the plurality of target conveyance containers 92 from the temporary storage device Ta (the control system HI controls the conveyance system T to do so) in a manner such that the shipment container 91 leads the conveyance containers 92 and the conveyance containers 92 follow the shipment container 91 in the housing sequence determined in the housing sequence determination processing. In the illustrated example, three target conveyance containers 92 are carried out successively from the temporary storage device Ta following the target shipment container 91. These containers are conveyed by the third conveyance system T3 from the temporary storage device Ta to the consolidation work area 3.

### Other Embodiments

Next, the following describes other embodiments.

(1) In the above embodiments, an example is described in which the article housing work is performed for each piece of order information Ia. However, there is no limitation to this example, and work relating to a plurality of pieces of order information Ia may be performed at a time in the article housing work. In this case, articles 8 indicated by the plurality of pieces of order information Ia are mixed in a single conveyance container 92. Accordingly, it is preferable to perform work for separating the articles 8 contained in the conveyance container 92 for the respective pieces of order information Ia after the article housing work.

(2) In the above embodiments, an example is described in which the conveyance system T includes the temporary storage device Ta for temporarily storing conveyance containers 92. However, there is no limitation to this example, and a configuration is also possible in which the conveyance system T does not include the temporary storage device Ta. In this case, the plurality of target conveyance containers 92 are conveyed by the second conveyance system T2 to the consolidation work area 3 in a sequence corresponding to the housing sequence determined in the housing sequence determination processing.

(3) In the above embodiments, an example is described in which the consolidation work is performed by a worker in the consolidation work area 3. However, there is no limitation to this example, and the consolidation work may also be performed by a robot, or by a robot and a worker.

(4) Note that the configurations disclosed in the above embodiments may be applied in combination with configurations disclosed in the other embodiments as long as no contradiction arises. As for other configurations as well, the embodiments disclosed in the present specification are merely examples in all aspects. Therefore, various modifications can be made as appropriate without departing from the gist of the present disclosure.

### Summary of Embodiments

The following describes a summary of the embodiments of the present disclosure.

An article shipping system configured to house at least one article in a shipment container in accordance with order information including at least one designated type of article and a corresponding type-specific designated number of articles for a shipment destination, the article shipping system including:
a container forming device configured to form the shipment container in any of a plurality of sizes by processing a raw material;
a housing work area in which article housing work is performed based on one or more pieces of the order information by housing one or more articles of one designated type in a target container that is at least one of the shipment container and a conveyance container;
a consolidation work area in which consolidation work is performed to, for each designated type in a certain piece of the order information, house the corresponding type-specific designated number of articles in the shipment container;
a conveyance system configured to convey the shipment container and the conveyance container; and
a control system configured to control the container forming device and the conveyance system,
wherein the control system executes housing sequence determination processing for determining a housing sequence in which articles of all designated types included in target order information are housed type by type in the shipment container, the target order information being each order information,
the container forming device forms a shipment container that has a size necessary to house the articles in the housing sequence determined in the housing sequence determination processing, as a target shipment container relating to the target order information, and
the control system controls the conveyance system in a manner such that, while the target shipment container and one or more target conveyance containers, in which the articles indicated by the target order information are housed, are conveyed to the consolidation work area, (i) the one or more target conveyance containers arrive at the consolidation work area in a sequence corresponding to the housing sequence determined in the housing sequence determination processing, and (ii) the target shipment container arrives at the consolidation work area before the target conveyance containers arrive.

According to this configuration, when the consolidation work for the plurality of articles indicated by the target order information is performed in the consolidation work area, it is possible to complete the consolidation work relating to the target order information by merely housing, in the target shipment container that arrives at the consolidation work area first, the articles housed in the target conveyance containers arriving after the target shipment container in the sequence in which the conveyance containers arrive. Moreover, the target shipment container is formed into a size necessary to house the articles in the determined housing sequence, and accordingly, it is easy to reduce the amount of dead space in the target shipment container when the consolidation work is complete and all the articles indicated by the target order information are housed in the target shipment container. Therefore, the articles can be housed with high efficiency. As described above, with this configuration, it is possible to supply a shipment container having a size that matches the total size of a group of articles indicated by order information at an appropriate timing and simplify the consolidation work.

It is preferable that the article shipping system further includes a work instruction output device installed in the consolidation work area and configured to output an instruction regarding the consolidation work to a worker, and
the work instruction output device outputs at least some of contents determined in the housing sequence determination processing in the consolidation work relating to the target order information.

According to this configuration, the worker can perform the consolidation work easily based on the instruction output by the work instruction output device.

It is preferable that the article housing work is performed in the housing work area with use of the shipment container and the conveyance containers as target containers,
the conveyance system includes a temporary storage device configured to temporarily store the shipment container and the conveyance containers,
the temporary storage device stores the target shipment container and the target conveyance containers until all of the target shipment container and the target conveyance containers relating to the target order information are conveyed to the temporary storage device, and
the control system controls the conveyance system in a manner such that the target shipment container and the target conveyance containers stored in the temporary storage device are carried out from the temporary storage device toward the consolidation work area in a sequence corresponding to the housing sequence determined in the housing sequence determination processing.

With this configuration, it is possible to convey the plurality of articles indicated by the target order information to the consolidation work area in an appropriate sequence corresponding to the housing sequence in which the articles are housed in the target shipment container. Moreover, according to this configuration, it is possible to house some of the articles indicated by the target order information in the target shipment container before the target shipment container arrives at the consolidation work area, i.e., before the consolidation work is performed, and to convey the target shipment container housing some of the articles to the consolidation work area. In other words, the target shipment container can also serve as a conveyance container. When compared with a case where an empty target shipment container that is to be used in the consolidation work is conveyed to the consolidation work area, this configuration can reduce the number of containers involved in the consolidation work relating to the target order information, and accordingly, the conveyance efficiency of the conveyance system can be easily increased.

It is preferable that the article housing work is performed in the housing work area with use of the conveyance containers as target containers,
the conveyance system includes a temporary storage device configured to temporarily store the shipment container and the conveyance containers, and conveys the empty shipment container formed by the container forming device to the temporary storage device,
the temporary storage device stores the target shipment container and the target conveyance containers until all of the target shipment container and the target conveyance containers relating to the target order information are conveyed to the temporary storage device, and
the control system controls the conveyance system in a manner such that the target shipment container stored in the temporary storage device is carried out from the temporary storage device toward the consolidation work area and thereafter the target conveyance containers stored in the temporary storage device are carried out from the temporary storage device toward the consolidation work area in a sequence corresponding to the housing sequence determined in the housing sequence determination processing.

According to this configuration, the target shipment container can arrive at the consolidation work area first, and thereafter the plurality of target conveyance containers can arrive at the consolidation work area in the sequence corresponding to the housing sequence determined in the housing sequence determination processing. Therefore, in the consolidation work area, it is possible to house all the articles indicated by the target order information in the target shipment container by merely performing the consolidation work in the sequence in which the containers arrive.

It is preferable that the article housing work is performed in the housing work area with use of the conveyance containers as target containers,
the conveyance system includes a temporary storage device configured to temporarily store the conveyance containers,
the temporary storage device stores the target conveyance containers until all of the target conveyance containers relating to the target order information are conveyed to the temporary storage device,
the control system controls the container forming device in a manner such that the target shipment container is formed after all the target conveyance containers relating to the target order information have been stored, and controls the conveyance system in a manner such that the formed target shipment container arrives at the consolidation work area by being conveyed along a route that does not pass through the temporary storage device, and
the control system controls the conveyance system in a manner such that (i) the target conveyance containers stored in the temporary storage device are carried out from the temporary storage device toward the consolidation work area in a sequence corresponding to the housing sequence determined in the housing sequence determination processing, and (ii) the target shipment container arrives at the consolidation work area before the target conveyance containers arrive at the consolidation work area.

According to this configuration, the target shipment container can be formed by the container forming device at a timing close to the timing at which the consolidation work is performed. Therefore, when the order information is changed right before the consolidation work, for example, it is possible to form the target shipment container corresponding to the changed order information. Moreover, the formed target shipment container is conveyed along a route different from the route along which the target conveyance containers are conveyed to the consolidation work area, and therefore, it is easy to make the target shipment container arrive at the consolidation work area earlier than the target conveyance containers.

### Industrial Applicability

The technology according to the present disclosure can be used for an article shipping system configured to house articles in a shipment container in accordance with order information including: designated types that are types of articles designated for each shipment destination; and type-specific designated numbers that are numbers of articles designated for the respective designated types.

What is claimed is:

1. An article shipping system configured to house at least one article in a shipment container in accordance with order information including at least one designated type of article and a corresponding type-specific designated number of articles for a shipment destination, the article shipping system comprising:
a container forming device configured to form the shipment container in any of a plurality of sizes by processing a raw material;
a housing work area in which article housing work is performed based on one or more pieces of the order information by housing one or more articles of one designated type in a target container that is at least one of the shipment container and a conveyance container;
a consolidation work area in which consolidation work is performed to, for each designated type in a certain piece of the order information, house the corresponding type-specific designated number of articles in the shipment container;
a conveyance system configured to convey the shipment container and the conveyance container; and
a control system configured to control the container forming device and the conveyance system, and
wherein:
the control system executes housing sequence determination processing for determining a housing sequence in which articles of all designated types included in target order information are housed type by type in the shipment container, the target order information being each order information,
the container forming device forms a shipment container that has a size necessary to house the articles in the housing sequence determined in the housing sequence determination processing, as a target shipment container relating to the target order information, and
the control system controls the conveyance system in a manner such that, while the target shipment container and one or more target conveyance containers, in which the articles indicated by the target order information are housed, are conveyed to the consolidation work area, (i) the one or more target conveyance containers arrive at the consolidation work area in a sequence corresponding to the housing sequence determined in the housing sequence determination processing, and (ii) the target shipment container arrives at the consolidation work area before the target conveyance containers arrive.

2. The article shipping system according to claim 1, further comprising:
a work instruction output device installed in the consolidation work area and configured to output an instruction regarding the consolidation work to a worker, and
wherein the work instruction output device outputs at least some of contents determined in the housing sequence determination processing in the consolidation work relating to the target order information.

3. The article shipping system according to claim 1, wherein:
the article housing work is performed in the housing work area with use of the shipment container and the conveyance containers as target containers,
the conveyance system comprises a temporary storage device configured to temporarily store the shipment container and the conveyance containers,
the temporary storage device stores the target shipment container and the target conveyance containers until all of the target shipment container and the target conveyance containers relating to the target order information are conveyed to the temporary storage device, and
the control system controls the conveyance system in a manner such that the target shipment container and the target conveyance containers stored in the temporary storage device are carried out from the temporary storage device toward the consolidation work area in a sequence corresponding to the housing sequence determined in the housing sequence determination processing.

4. The article shipping system according to claim 1, wherein:
the article housing work is performed in the housing work area with use of the conveyance containers as target containers,
the conveyance system comprises a temporary storage device configured to temporarily store the shipment container and the conveyance containers, and conveys the empty shipment container formed by the container forming device to the temporary storage device,
the temporary storage device stores the target shipment container and the target conveyance containers until all of the target shipment container and the target conveyance containers relating to the target order information are conveyed to the temporary storage device, and
the control system controls the conveyance system in a manner such that the target shipment container stored in the temporary storage device is carried out from the temporary storage device toward the consolidation work area and thereafter the target conveyance containers stored in the temporary storage device are carried out from the temporary storage device toward the consolidation work area in a sequence corresponding to the housing sequence determined in the housing sequence determination processing.

5. The article shipping system according to claim 1, wherein:
the article housing work is performed in the housing work area with use of the conveyance containers as target containers,
the conveyance system comprises a temporary storage device configured to temporarily store the conveyance containers,
the temporary storage device stores the target conveyance containers until all of the target conveyance containers relating to the target order information are conveyed to the temporary storage device,
the control system controls the container forming device in a manner such that the target shipment container is formed after all the target conveyance containers relating to the target order information have been stored, and controls the conveyance system in a manner such that the formed target shipment container arrives at the consolidation work area by being conveyed along a route that does not pass through the temporary storage device, and
the control system controls the conveyance system in a manner such that (i) the target conveyance containers stored in the temporary storage device are carried out from the temporary storage device toward the consolidation work area in a sequence corresponding to the housing sequence determined in the housing sequence determination processing, and (ii) the target shipment container arrives at the consolidation work area before the target conveyance containers arrive at the consolidation work area.
